(19) United States
(12) Patent Application Publication
(10) Pub. No.: US 2015/0156849 A1
(43) Pub. Date: Jun. 4, 2015

(54) OPTICALLY CONTROLLED LIGHTING DEVICE AND CONTROL METHOD THEREOF

(71) Applicant: LivingStyle Enterprises Limited, Dong Guan City (CN)

(72) Inventor: Ming-Yun Chen, Dong Guan City (CN)

(73) Assignee: LivingStyle Enterprises Limted, Dong Guan City (CN)

(21) Appl. No.: 14/386,893

(22) PCT Filed: Mar. 22, 2013
(86) PCT No.: PCT/CN2013/073080

§ 371 Date: Dec. 23, 2014

(30) Foreign Application Priority Data
Mar. 22, 2012 (CN) 201210077964.7
Apr. 20, 2012 (CN) 201210118564.6
Apr. 20, 2012 (CN) 201220171735.7

(51) Int. Cl. H05B 37/02; F21V 29/70; H05B 33/08

(52) U.S. Cl. CPC H05B 37/0218; H05B 37/0272; H05B 33/0854; F21V 29/70

(57) ABSTRACT

An optically controlled lighting device and a control method thereof are provided. The optically controlled lighting device includes a lighting main body, a dimming time controller and an optical detector. The control method includes the following steps. In a step (a), the lighting main body, including a controlling circuit and a light source, the dimming time controller and the optical detector are provided. In a step (b), the dimming time controller is enabled to respectively generate an on/off dimming signal, and the light source is respectively turned on/turned off during an on/off period respectively corresponding to the on/off dimming signal, wherein the off period is shorter than the time period for producing persistence of vision. In a step (c), an ambient light intensity is detected by the optical detector during the off period, the brightness of the light source is increased or decreased or the light source is turned off.

### FIELD OF THE INVENTION

The present invention relates to a lighting technology, and more particularly to an optically controlled lighting device for detecting the ambient light intensity and a control method thereof.

### BACKGROUND OF THE INVENTION

Nowadays, lighting devices are widely used in workshops, working platforms, walkways, offices, houses, roads, courtyards, public places or a variety of indoor/outdoor environments, and bring a lot of convenience to the human lives. For example, the wisely-used lighting devices at least comprise light bulbs, light tubes, various lamps (e.g. a ceiling lamp or a garden lamp) or various work lamps (e.g. a work lamp with a humidifying function or a work lamp with a spraying function). The light sources used in these lighting devices are for example incandescent light bulbs, fluorescent lamps or environmentally-friendly and power-saving LED lamps.

Conventionally, for achieving the power-saving efficacy of the lighting device, a passive infrared (PIR) sensor for sensing a movement of a human body in a sensing region in order to judge whether a user appears. If the user appears in the sensing region, the lighting device is controlled to implement a lighting action. Consequently, the power-saving purpose can be achieved to some extents.

In case that the PIR sensor is only used to execute the sensing function, the lighting device is controlled to implement the lighting action whenever the user appears in the sensing region. However, even if the ambient light of the sensing region has sufficient brightness, the lighting action is still implemented whenever the user appears in the sensing region. The way of additionally implementing the lighting action of the lighting device wastes electric power. Similarly, after a general light source is turned on for a certain time period, if the ambient light is gradually changed and the user feels that the ambient light has sufficient brightness, the user has to stand up and then turn of the light source. If the switch of the light source is far away from the user or the user is handicapped, the process of frequently turning on or turning off the switch of the light source is troublesome to the user.

On the other hand, another environmentally-friendly and power-saving lamp uses a photosensitive sensing circuit to detect the brightness of the ambient light. If the brightness is higher than a predetermined value, it means that the environment is relatively brighter. Under this circumstance, the power-saving lamp is maintained in the off state. Whereas, if the brightness is lower than a predetermined value, it means that the environment is relatively darker. Consequently, the power-saving lamp is automatically turned on. After the power-saving lamp is turned on, the photosensitive sensing circuit may immediately or intermittently detect the brightness of the ambient light. If the brightness is higher than the predetermined value, the power-saving lamp is automatically turned off. Consequently, the power-saving purpose is achieved. However, the operating method of this power-saving lamp still has some drawbacks. For example, while the photosensitive sensing circuit detects the brightness of the ambient light, the detecting result is possibly influenced by the light beam from the power-saving lamp. For avoiding the influence on the detecting result of the photosensitive sensing circuit, the photosensitive sensing circuit is usually located at a position outside the illuminated region of the power-saving lamp. Consequently, the brightness of the ambient light detected by the photosensitive sensing circuit may be considered as the real brightness of the ambient light. In other words, for installing the power-saving lamp, the lighting module of the power-saving lamp is placed at one position and the photosensitive sensing circuit is placed at another position. Then, the lighting module of the power-saving lamp and the photosensitive sensing circuit are electrically connected with each other. As mentioned above, it is inconvenient to install the power-saving lamp, and the installation cost of the power-saving lamp is high. For example, a long conductive wire is required to connect the lighting module of the power-saving lamp with the photosensitive sensing circuit. Moreover, the demands on the installation site of the power-saving lamp are stringent. For example, it is necessary that the photosensitive sensing circuit is installed at the position outside the illuminated region of the power-saving lamp.

For solving the above drawbacks and achieving the power-saving purpose, there is a need of providing a lighting device for detecting the intensity of the ambient light in order to judge whether the lighting device needs to implement the lighting action or not. Moreover, for installing the lighting device, the photosensitive sensing circuit does not need to be far away from the lighting module.

### SUMMARY OF THE INVENTION

An object of the present invention provides an optically controlled lighting device with an optical detector and a control method thereof so as to eliminate the drawbacks of the prior art technologies. Consequently, the power-saving purpose is achieved by simply installing the optically controlled lighting device.

Another object of the present invention provides an optically controlled lighting group with an optical detector.

In accordance with an aspect of the present invention, there is provided an optically controlled lighting device. The optically controlled lighting device includes a lighting main body, a dimming time controller and an optical detector. The lighting main body includes a controlling circuit and a light source. The light source is electrically connected with the controlling circuit. The dimming time controller is coupled to the controlling circuit, and generates an on dimming signal and an off diming signal. When the on dimming signal is transmitted to the controlling circuit, the light source is turned on during an on period corresponding to the on dimming signal. When the off dimming signal is transmitted to the controlling circuit, the light source is turned off during an off period corresponding to the off dimming signal. The optical detector is coupled to the controlling circuit, and detects an ambient light intensity. The off period is shorter than a time period for producing persistence of vision. If the ambient light intensity detected by the optical detector is different from a predetermined value, the light source is controlled by the dimming time controller.

In an embodiment, the optically controlled lighting device further includes a sensing element that senses a movement of an object, wherein the sensing element is disposed within the lighting main body and electrically connected with the controlling circuit.

In an embodiment, the optically controlled lighting device is at least selected from one of a sensing type LED light bulb, a sensing type LED light tube, a sensing type lamp and a sensing type work lamp. The sensing type lamp is at least selected from a sensing type ceiling lamp or a sensing type garden lamp, and the sensing type work lamp is at least selected from a sensing type work lamp with a spraying function or a sensing type work lamp with a humidifying function.

In an embodiment, if the optically controlled lighting device is the sensing type LED light bulb, the sensing type LED light bulb includes a bulb main body, and the bulb main body is used as the lighting main body. The bulb main body further at least includes a male connector, a bulb casing, a LED light source set and a bulb cover. The male connector is located at a first end of the bulb casing. The LED light source set and the bulb cover are both disposed within the bulb casing and located at a second end of the bulb casing opposed to the first end of the bulb casing. The LED light source set is covered by the bulb cover. The bulb casing is a heat-dissipating structure with an accommodation part. In addition, the accommodation part is in communication with the first end and the second end. At least one electronic component of the controlling circuit is accommodated within the accommodation part. Plural fins are disposed on an outer surface of the heat-dissipating structure. The male connector is located at the first end of the heat-dissipating structure. The LED light source set and the bulb cover are both located at the second end of the heat-dissipating structure. Otherwise, if the optically controlled lighting device is the sensing type LED light tube, the sensing type LED light tube include a tube main body, and the tube main body is used as the lighting main body. The sensing type LED light tube further at least includes two tube caps, a non-closed-circular tube casing, a LED light source set and a tube cover. The two tube caps are respectively located at two ends of the non-closed-circular tube casing. The LED light source set and the tube cover are both connected to an entrance of the non-closed-circular tube casing. The LED light source set is covered by the tube cover. The non-closed-circular tube casing is a non-closed-circular heat-dissipating structure. Plural fins are disposed on an outer surface of the non-closed-circular heat-dissipating structure. The two tube caps are respectively located at the two ends of the circular heat-dissipating structure. The LED light source set and the tube cover are both connected to the entrance of the non-closed-circular heat-dissipating structure. Otherwise, if the sensing type lamp is the sensing type ceiling lamp or the sensing type garden lamp or the sensing type work lamp is the sensing type work lamp with the spraying function or the sensing type work lamp with the humidifying function, the light source is a LED light source set comprising plural LED chips, or the light source is an incandescent light source set or a fluorescent light source set.

In an embodiment, the optically controlled lighting device further includes an electromagnetic wireless communication module. The electromagnetic wireless communication module is disposed within the lighting main body and electrically connected with the controlling circuit. The electromagnetic wireless communication module is operated in a frequency band of an invisible light spectrum. The electromagnetic wireless communication module is at least selected from one of a 313.325 MHz wireless communication module, a 433 MHz wireless communication module, a 418 MHz wireless communication module, a 2.4 GHz wireless communication module, a 5.8 GHz wireless communication module, a 10 GHz wireless communication module, a Bluetooth wireless communication module, a Wi-Fi wireless communication module, a NFC wireless communication module, a Z-Wave wireless communication module and a ZigBee wireless communication module. Otherwise, the optically controlled lighting device further includes an electromagnetic wireless communication module. The electromagnetic wireless communication module is disposed within the lighting main body and electrically connected with the controlling circuit. The electromagnetic wireless communication module is operated in a frequency band of a visible light spectrum.

In an embodiment, the optically controlled lighting device further at least includes a music player and/or a safety monitoring device. Moreover, the music player and/or the safety monitoring device are disposed within lighting main body and electrically connected with the controlling circuit.

In an embodiment, the optically controlled lighting device is an outdoor optically controlled lighting device, and the outdoor optically controlled lighting device further includes a solar battery. Moreover, the solar battery is electrically connected with the controlling circuit.

In an embodiment, the optically controlled lighting device further includes at least one charger. The charger is electrically connected to the lighting main body. If a utility power source is available, the lighting main body selectively controls any of the utility power source and the at least one charger to provide electric power to the light source. If the utility power source is interrupted, the at least one charger provides electric power to the light source.

In accordance with an aspect of the present invention, there is provided an optically controlled lighting group. The optically controlled lighting group includes a first optically controlled lighting device and a second optically controlled lighting device. The first optically controlled lighting device includes a first light source, a first communication module, a dimming time controller, an optical detector and a first controlling circuit. The first controlling circuit is electrically connected with the first light source, the first communication module, the dimming time controller and the optical detector. The second optically controlled lighting device includes a second light source, a second communication module and a second controlling circuit. The second controlling circuit is electrically connected with the second light source and the second communication module. The dimming time controller is coupled with the first controlling circuit, and generates an on dimming signal and an off diming signal. When the on dimming signal is transmitted to the first controlling circuit, the first light source is turned on during an on period corresponding to the on dimming signal. When the off dimming signal is transmitted to the first controlling circuit, the first light source is turned off during an off period corresponding to the off dimming signal. The off period is shorter than a time period for producing persistence of vision. If the ambient light intensity detected by the optical detector is different from a predetermined value, the first light source is controlled by the dimming time controller.

In an embodiment, the first optically controlled lighting device further includes a first sensing element that senses a movement of an object, and the first sensing element is electrically connected with the first controlling circuit. According to an environmental sensing result of the first sensing element, a communication channel between the first communication module and the second communication module is established, so that a light intensity of the first light source and/or the second light source is correspondingly controlled.

In an embodiment, the first optically controlled lighting device has a master control function, and the second optically controlled lighting device has a controlled function. According to the environmental sensing result, the light intensity of the first light source is actively controlled by the first optically controlled lighting device. Moreover, the light intensity of the second light source of the second optically controlled lighting device is controlled in response to a control command from the first optically controlled lighting device.

In an embodiment, the second optically controlled lighting device further includes a second sensing element. The communication channel between the first communication module and the second communication module is established according to the environmental sensing result, so that the light intensity of the first light source and/or the second light source is correspondingly controlled.

In an embodiment, each of the first optically controlled lighting device and the second optically controlled lighting device has both of the master control function and the controlled function. When a lighting control program is automatically executed by the first optically controlled lighting device and the second optically controlled lighting device, the light intensity of the first light source and/or the second light source is correspondingly controlled.

In accordance with an aspect of the present invention, there is provided an optically controlled lighting device includes a controlling part and an optical control part. The optically controlled lighting device is turned on or turned off under control of the controlling part. The optical control part detects a brightness of an ambient light. The controlling part and the optical control part are disposed within the optically controlled lighting device, and the controlling part and the optical control part are electrically connected with each other. After the optically controlled lighting device is turned on, the optically controlled lighting device is turned off by the controlling part at fixed time intervals. While the optically controlled lighting device is turned off, the optical control part detects the brightness of the ambient light.

In an embodiment, the optically controlled lighting device is turned on or turned off under control of the controlling part according to a detecting result of detecting the brightness of the ambient light by the optical control part, wherein the optical control part is a photosensitive sensing circuit.

In an embodiment, the optically controlled lighting device further includes a sensing part that senses whether a human body appears. The sensing part is connected to the controlling part. The optically controlled lighting device is turned on or turned off under control of the controlling part according to a detecting result of detecting the brightness of the ambient light by the optical control part and a sensing result of sensing whether the human body appears in an illuminated region by the sensing part.

In an embodiment, the optically controlled lighting device further includes a LED light source set. The LED light source set includes plural LED chips. The plural LED chips have identical color temperature or luminance or chroma, or the color temperature or the luminance or the chroma of at least a portion of the plural LED chips is different from that of another portion of the plural LED chips.

In an embodiment, the optically controlled lighting device is at least selected from one of a sensing type LED light bulb, a sensing type LED light tube, a sensing type lamp and a sensing type work lamp. The sensing type lamp is at least selected from a sensing type ceiling lamp or a sensing type garden lamp. The sensing type work lamp is at least selected from a sensing type work lamp with a spraying function or a sensing type work lamp with a humidifying function.

In accordance with an aspect of the present invention, there is provided a control method for an optically controlled lighting device. The control method at least includes the following steps. Firstly, in a step (a), a lighting main body, a dimming time controller and an optical detector are provided. The lighting main body includes a controlling circuit and a light source. The light source, the dimming time controller and the optical detector are electrically connected to the controlling circuit. In a step (b), the dimming time controller is enabled to generate an on dimming signal. When the on dimming signal is transmitted to the controlling circuit, the light source is turned on during an on period corresponding to the on dimming signal. In a step (c), the dimming time controller is enabled to generate an off diming signal. When the off dimming signal is transmitted to the controlling circuit, the light source is turned off during an off period corresponding to the off dimming signal. The off period is shorter than the time period for producing persistence of vision. In a step (d), the optical detector detects an ambient light intensity during the off period. If the ambient light intensity detected by the optical detector is different from a predetermined value, the light source is correspondingly controlled by the dimming time controller.

In an embodiment, the step (d) further includes a step (d1), a step (d2) or a step (d3). In the step (d1), if the ambient light intensity detected by the optical detector is lower than the predetermined value, the dimming time controller issues a first brightness signal to the controlling circuit so as to increase or maintain a brightness of the light source. In the step (d2), if the ambient light intensity detected by the optical detector is not lower than the predetermined value, the dimming time controller issues a second brightness signal to the controlling circuit so as to decrease the brightness of the light source. In the step (d3), if the ambient light intensity detected by the optical detector is not lower than the predetermined value, the dimming time controller issues an off signal to the controlling circuit so as to turn off the light source.

In an embodiment, the controlling circuit is further electrically connected with a sensing element. A movement of an object is sensed by the sensing element. The sensing element is disposed within the lighting main body.

In accordance with an aspect of the present invention, there is provided a control method for an optically controlled lighting device. The control method at least includes the following steps. In a step (a′), the optically controlled lighting device is in an off state at fixed time intervals after the optically controlled lighting device is in an on state. In a step (b′), a brightness of an ambient light is detected while the optically controlled lighting device is in the off state. In a step (c′), if the brightness of the ambient light is higher than a predetermined value, the optically controlled lighting device is maintained in the off state, and the step (b′) is repeatedly done. If the brightness of the ambient light is lower than or equal to the predetermined value, the optically controlled lighting device is in the on state, and the step (a′) is repeatedly done.

In an embodiment, if the brightness of the ambient light is higher than the predetermined value in the step (c′), the optically controlled lighting device is maintained in the off state, and the step (b′) is repeatedly done. If the brightness of the ambient light is lower than or equal to the predetermined value in the step (c′), the control method further includes a step of judging whether a human body appears. If no human body appears, the optically controlled lighting device is maintained in the off state, and the step (b′) is repeatedly done. If the human body appears, the optically controlled lighting device is turned on, and the step (a′) is repeatedly done.

From the above descriptions, the optically controlled lighting device of the present invention is equipped with a dimming time controller to control the on state and the off state of the lighting main body. Moreover, during an off period that the lighting main body is in the off state, an ambient light intensity is detected by the optical detector in order to judge whether the brightness of the ambient light is sufficient. If the brightness of the ambient light is sufficient, the brightness of the lighting main body is decreased or the light source of the lighting main body is turned off. If the brightness of the ambient light is insufficient, the brightness of the lighting main body is increased or maintained. By means of this design, the optical detector is not away from the lighting main body. Moreover, since the off period is shorter than the time period for producing persistence of vision, the flickering light of the optically controlled lighting device is not sensed by the human eyes. Moreover, since the optically controlled lighting device selectively implements the lighting action according to the result of judging the ambient light intensity, the purposes of saving electric power and balancing the brightness of the lighting zone can be achieved. Moreover, since the user does not need to frequently turn on and turn off the light source, the switch of the light source can be continuously in the on state.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating a microwave sensing type LED light bulb with a microwave sensor and an electromagnetic wireless communication module and used as an optically controlled lighting device according to an embodiment of the present invention;

FIG. 2 is a schematic perspective view illustrating the combination of a LED light source set and a bulb casing of the microwave sensing type LED light bulb of FIG. 1;

FIG. 3 is a schematic perspective view illustrating the bulb casing of the microwave sensing type LED light bulb of FIG. 1;

FIG. 4 is a schematic perspective view illustrating the bulb casing of the microwave sensing type LED light bulb of FIG. 1 and taken along another viewpoint;

FIG. 5 is a schematic perspective view illustrating a controlling circuit of the microwave sensing type LED light bulb of FIG. 1;

FIG. 6 is a schematic perspective view illustrating a portion of a sensing circuit of the microwave sensor of the microwave sensing type LED light bulb of FIG. 1;

FIG. 7 is a schematic partial circuit diagram of the optically controlled lighting device of the present invention;

FIG. 8 is a flowchart illustrating a control method of the optically controlled lighting device of the present invention;

FIG. 9 is a flowchart illustrating a control method of the optically controlled lighting device with a sensing part according to an embodiment of the present invention;

FIG. 10 is a schematic perspective view illustrating a PIR sensing type LED light bulb with a PIR sensor and an electromagnetic wireless communication module and used as an optically controlled lighting device according to an embodiment of the present invention;

FIG. 11 is a schematic perspective view illustrating a microwave sensing type LED light tube with a microwave sensor and an electromagnetic wireless communication module and used as an optically controlled lighting device according to an embodiment of the present invention;

FIG. 12 is a schematic perspective view illustrating a PIR sensing type LED light tube with a PIR sensor and an electromagnetic wireless communication module and used as an optically controlled lighting device according to an embodiment of the present invention;

FIG. 13 is a schematic perspective view illustrating a microwave sensing type ceiling lamp with a microwave sensor and an electromagnetic wireless communication module and used as an optically controlled lighting device according to an embodiment of the present invention;

FIG. 14 is a schematic perspective view illustrating a microwave sensing type work lamp with a microwave sensor and an electromagnetic wireless communication module and used as an optically controlled lighting device according to an embodiment of the present invention;

FIG. 15 is a schematic perspective view illustrating a microwave sensing type garden lamp with a microwave sensor and an electromagnetic wireless communication module and used as an optically controlled lighting device according to an embodiment of the present invention;

FIG. 16 schematically illustrates a group control mechanism of an optically controlled lighting group including plural optically controlled lighting devices according to a first embodiment of the present invention;

FIG. 17 schematically illustrates a group control mechanism of an optically controlled lighting group including plural optically controlled lighting devices according to a second embodiment of the present invention;

FIG. 18 schematically illustrates a group control mechanism according to a third embodiment of the present invention by integrating the concepts of the group control mechanism of FIG. 16 with the group control mechanism of FIG. 17;

FIG. 19 is a flowchart illustrating a method of performing the group control mechanism according to an embodiment of the present invention;

FIG. 20 is a schematic plot illustrating the comparison between associated signals of the LED light source set and the optical detector of the optically controlled lighting device in a first situation;

FIG. 21 is a schematic plot illustrating the comparison between associated signals of the LED light source set and the optical detector of the optically controlled lighting device in a second situation;

FIG. 22 is a schematic plot illustrating the comparison between associated signals of the LED light source set and the optical detector of the optically controlled lighting device in a third situation; and

FIG. 23 is a flowchart illustrating a method of performing the group control mechanism according to another embodiment of the present invention.

### DETAILED DESCRIPTION OF THE PREFERRED EMBODIMENT

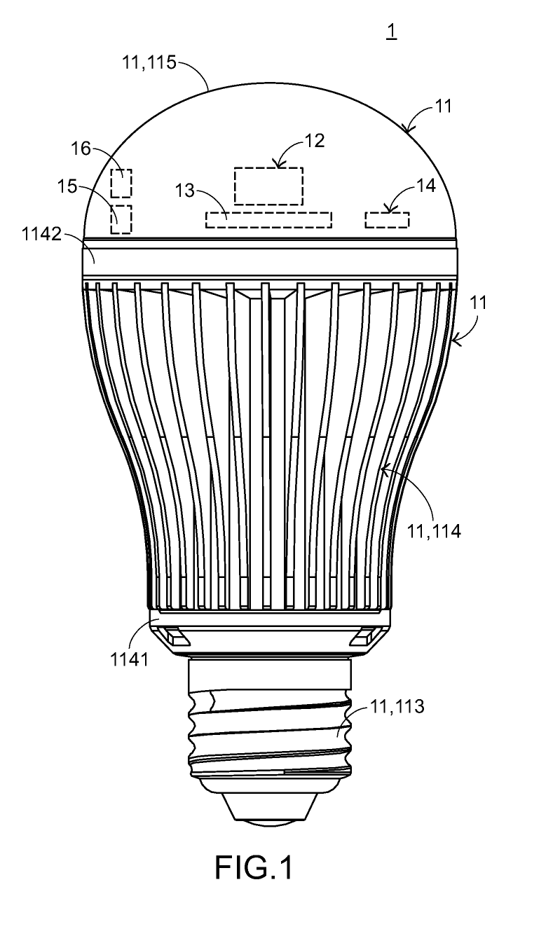

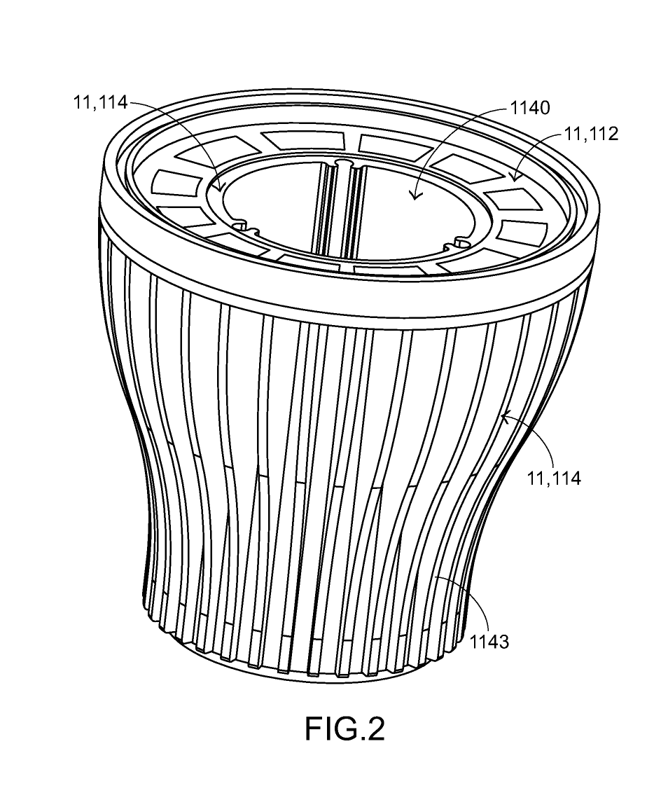

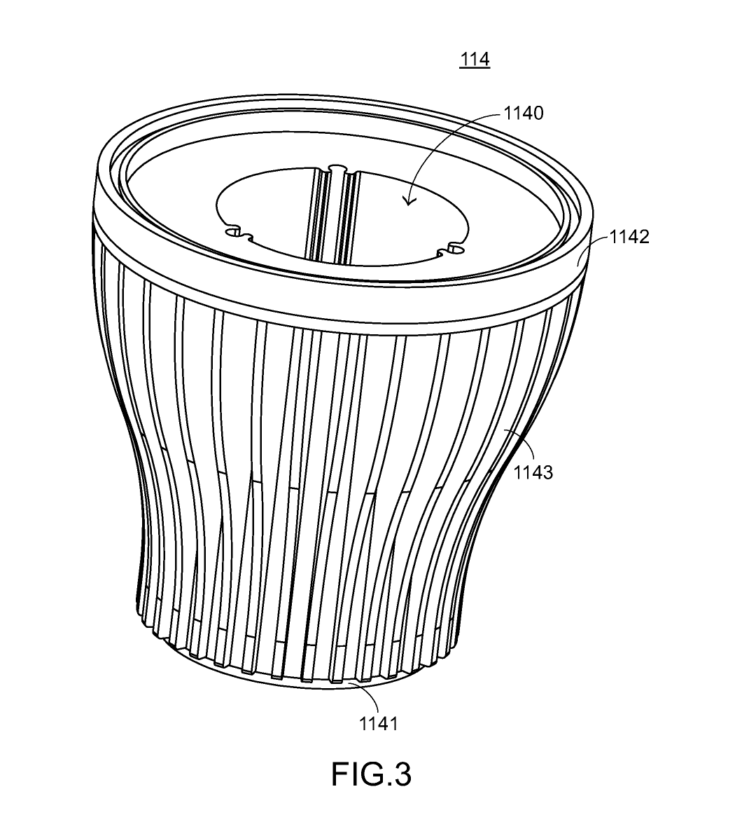

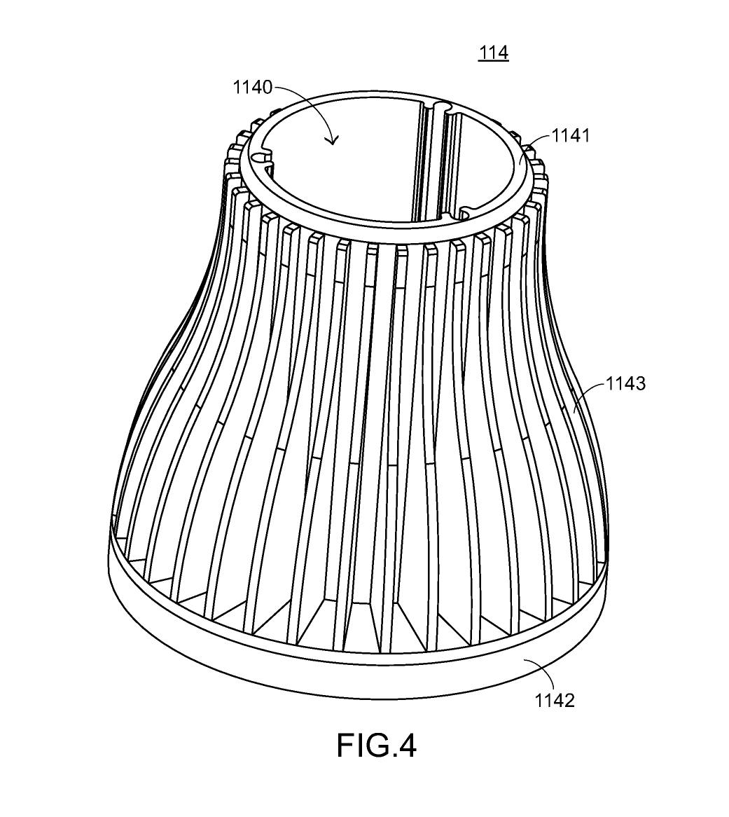

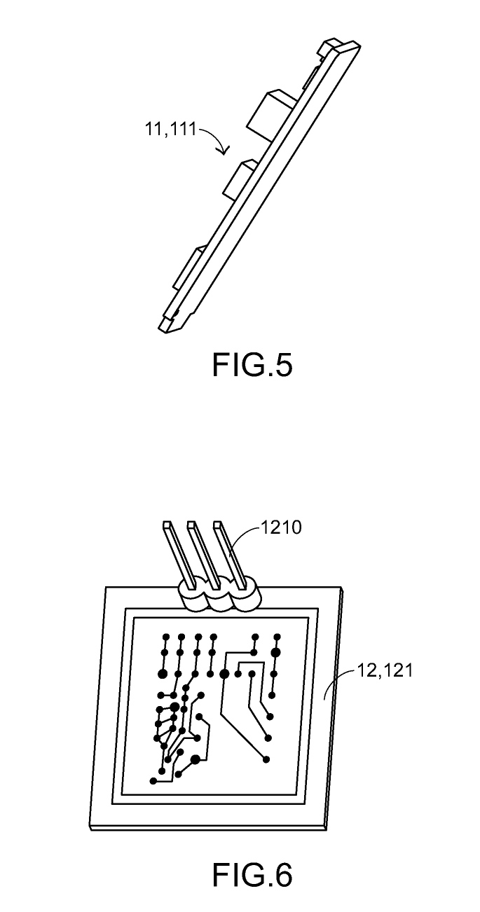

Please refer to FIGS. 1˜6. FIG. 1 is a schematic perspective view illustrating a microwave sensing type LED light bulb with a microwave sensor and an electromagnetic wireless communication module and used as an optically controlled lighting device according to an embodiment of the present invention. FIG. 2 is a schematic perspective view illustrating the combination of a LED light source set and a bulb casing of the microwave sensing type LED light bulb of FIG. 1. FIG. 3 is a schematic perspective view illustrating the bulb casing of the microwave sensing type LED light bulb of FIG. 1. FIG. 4 is a schematic perspective view illustrating the bulb casing of the microwave sensing type LED light bulb of FIG. 1 and taken along another viewpoint. FIG. 5 is a schematic perspective view illustrating a controlling circuit of the microwave sensing type LED light bulb of FIG. 1. FIG. 6 is a schematic perspective view illustrating a portion of a sensing circuit of the microwave sensor of the microwave sensing type LED light bulb of FIG. 1.

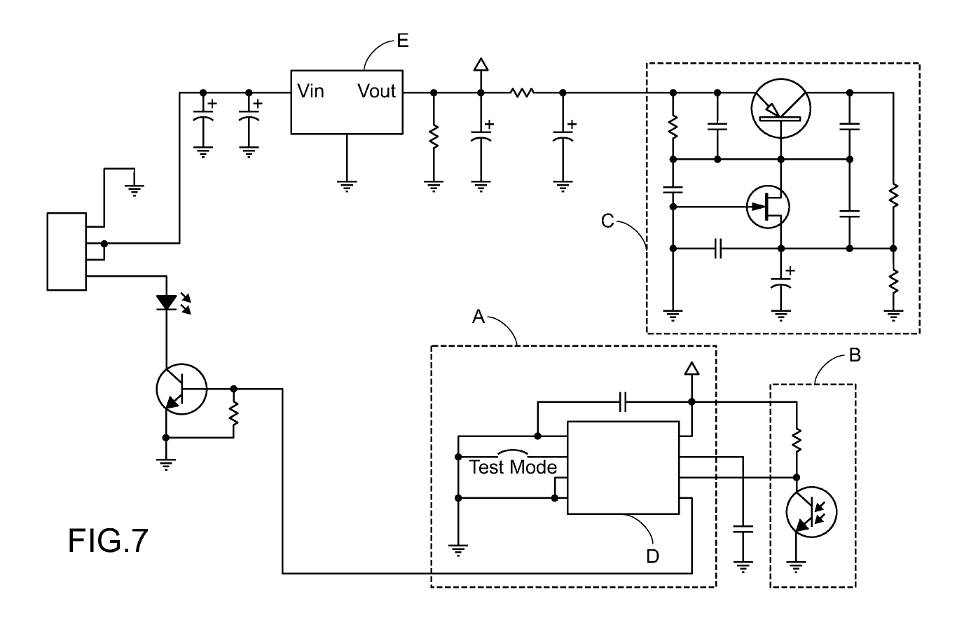

In an embodiment, the optically controlled lighting device 1 is a microwave sensing type LED light bulb. The microwave sensing type LED light bulb 1 comprises a bulb main body 11, a dimming time controller 15 and an optical detector 16. The bulb main body 11 is used as a lighting main body. Moreover, the bulb main body 11 at least comprises a controlling circuit 111 and a light source 112. The light source 112 is electrically connected with the controlling circuit 111. For example, the light source 112 is a LED light source set. Moreover, the dimming time controller 15 and the optical detector 16 are also coupled to the controlling circuit 111. Please also refer to FIG. 7, which is a partial circuit diagram of the optically controlled lighting device of the present invention. It is noted that the controlling circuit 111 and the dimming time controller 15 may be separately arranged in the optically controlled lighting device 1 of the present invention. Nevertheless, the controlling circuit 111 (with a control IC chip D) and the dimming time controller 15 may be integrated into a controlling device (i.e. a controlling part A) by the manufacturer. Under this circumstance, the controlling part A may contain the functions of the controlling circuit 111 and the dimming time controller 15. It is noted that the arrangement of the controlling circuit 111 and the dimming time controller 15 may be varied by the manufacturer according to the practical requirements. Moreover, the optical detector 16 belongs to an optical control part B. An example of the optical detector 16 includes but is not limited to a photoresistor or a photosensitive sensing circuit. More preferably, the controlling part A and the optical control part B are disposed within the optically controlled lighting device 1. Moreover, the optically controlled lighting device 1 may be equipped with a voltage regulator IC chip E. In case that the input voltage is subjected to a change, a stabilized output current can still be maintained by the voltage regulator IC chip E.

Moreover, the dimming time controller 15 is used for generating an on dimming signal and an off diming signal. When the on dimming signal is transmitted to the controlling circuit 111, the on dimming signal is correlated with an on period. During the on period, the LED light source set 112 is turned on. When the off dimming signal is transmitted to the controlling circuit 111, the off dimming signal is correlated with an off period. During the off period, the LED light source set 112 is turned off. Moreover, the optical detector 16 may quickly detect an ambient light intensity during the off period. If the ambient light intensity is different from a predetermined value, the dimming time controller 15 may control the light source set 112 to increase, decrease or maintain the brightness or turn off the light source set 112.

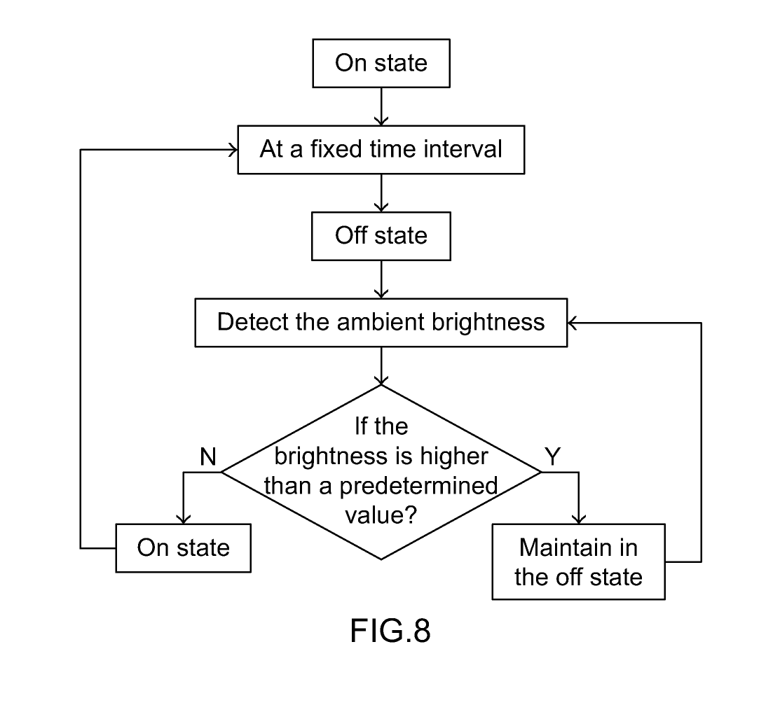

FIG. 8 is a flowchart illustrating a control method of the optically controlled lighting device 1 of the present invention. Please refer to FIGS. 7 and 8. While the optically controlled lighting device 1 is turned off (i.e. in the off state), the optical control part B immediately detects the brightness of the ambient light and transmits the detecting result to the controlling part A. If the detected brightness is higher than the predetermined value (e.g. in the daytime), the controlling part A controls the optically controlled lighting device 1 to be maintained in the off state. If the detected brightness is lower than or equal to the predetermined value (e.g. at night), the optically controlled lighting device 1 is turned on under control of the controlling part A.

After the optically controlled lighting device 1 is turned on (i.e. in the on state), the optically controlled lighting device 1 is automatically turned off by the controlling part A at fixed time intervals. While the optically controlled lighting device 1 is turned off, the optical control part B detects the brightness of the ambient light and transmits the detecting result to the controlling part A. If the detected brightness is higher than the predetermined value, the controlling part A controls the optically controlled lighting device 1 to be maintained in the off state. If the detected brightness is lower than or equal to the predetermined value, the optically controlled lighting device 1 is turned on under control of the controlling part A. In an embodiment, the processing time length from the time point of turning off the optically controlled lighting device 1 and detecting the brightness of the ambient light to the time point of re-turning on the optically controlled lighting device 1 is about 1/24 second to 1 millisecond. The reasons will be illustrated later.

In brief, while the optically controlled lighting device 1 is in the off state, the detecting result is not influenced by the light beam from the optically controlled lighting device 1. Under this circumstance, the optical control part B only needs to perform the normal optical detecting step. Consequently, the controlling part A can make accurate judgment and take accurate control measure according to the detecting result. On the other hand, while the optically controlled lighting device 1 is in the on state, the detecting result of the optical control part B may be influenced by the light beam from the optically controlled lighting device 1. Under this circumstance, the optically controlled lighting device 1 has to be shortly turned off. Consequently, the optical control part B can accurately judge the brightness of the ambient light, and the controlling part A can make accurate judgment according to the detecting result.

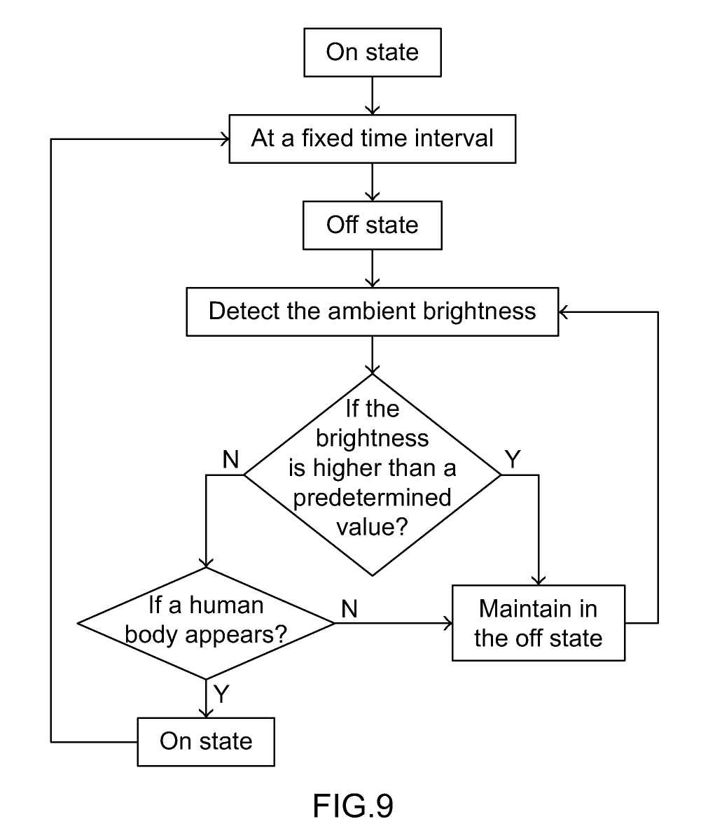

FIG. 9 is a flowchart illustrating a control method of the optically controlled lighting device with a sensing part according to an embodiment of the present invention. Please refer to FIGS. 7 and 9. Moreover, the sensing part C is a passive infrared (PIR) sensor or a microwave sensor, but is not limited thereto. For example, the sensing part C may be a sensing element using a special optical wave to perform an optical sensing control operation by sensing whether a human body moves or an objected is moved.

Preferably, at least a portion of the sensing part C is disposed within the optically controlled lighting device 1 and electrically connected with the controlling part A. The connecting relationship between the sensing part C and the controlling part A is shown in FIG. 7. After the sensing part C executes the sensing function, the sensing result is transmitted to the controlling part A. According to the sensing result of the sensing part C and the detecting result of the optical control part B, the optically controlled lighting device 1 is turned on or turned off under control of the controlling part A. The detailed procedures of the controlling flowchart will be illustrated with reference to FIG. 9. While the optically controlled lighting device 1 is turned off, the optical control part B detects the brightness of the ambient light and the sensing part C also senses the environment. The detecting result of the optical control part B and the sensing result of the sensing part C are transmitted to the controlling part A. Regardless of whether the sensing part C senses the presence of a human body in the environment, if the brightness detected by the optical control part B is higher than the predetermined value (e.g. in the daytime), the controlling part A controls the optically controlled lighting device 1 to be maintained in the off state. If the brightness detected by the optical control part B is lower than or equal to the predetermined value (e.g. at night), the controlling part A will further judge whether a human body appears in the environment according to the sensing result of the sensing part C. If no human body appears in the illuminated region of the optically controlled lighting device 1, the controlling part A controls the optically controlled lighting device 1 to be maintained in the off state. Whereas, if a human body appears in the illuminated region, the optically controlled lighting device 1 is turned on under control of the controlling part A.

After the optically controlled lighting device 1 is turned on, the optically controlled lighting device 1 is automatically turned off by the controlling part A at fixed time intervals. While the optically controlled lighting device 1 is turned off, the optical control part B detects the brightness of the ambient light and transmits the detecting result to the controlling part A. If the brightness detected by the optical control part B is higher than the predetermined value, the controlling part A is maintained in the off state under control of the optically controlled lighting device 1. Similarly, if the brightness detected by the optical control part B is lower than or equal to the predetermined value, the controlling part A will further judge whether a human body appears in the illuminated region according to the sensing result of the sensing part C. If no human body appears in the illuminated region of the optically controlled lighting device 1, the controlling part A controls the optically controlled lighting device 1 to be maintained in the off state. Whereas, if a human body appears in the illuminated region, the optically controlled lighting device 1 is turned on under control of the controlling part A.

In the above embodiment, the brightness of the ambient light and the practical requirement (i.e. the presence or absence of a human body in the illuminated region) are taken into consideration. In case that the optical control part B and the controlling part A are used as the basic components, the optically controlled lighting device 1 may be equipped with the sensing part C to detect whether a human body appears. Consequently, the optically controlled lighting device 1 is turned on or turned off more user-friendly, and the environmentally-friendly and power-saving purposes are achieved.

Generally, the persistence of vision is the theory where an image is thought to persist for approximately one twenty-fourth of a second on the retina of the human eyes. For preventing from the human perception of the flickering light, the off period is set to be shorter than 1/24 second. Consequently, the off state of LED light source set 112 is too short to be sensed by the eyes of the user. Preferably, the off period is in the range between 1/24 second and 1 millisecond. The length of the off period may be varied according to the practical requirements of the user. Moreover, since the LED light source set 112 is temporarily turned off in the off period by this design, the heat generation is temporarily stopped. Under this circumstance, the possibility of causing the overheated condition of the LED light source set 112 will be minimized. Moreover, the plural light sources of the LED light source set 112 may be sequentially and alternately enabled to illuminate at specified time intervals, wherein the specified time interval is shorter than the time period for producing persistence of vision. Consequently, the time points of enabling the plural light sources are allocated and the generated heat amount is reduced while achieving the similar lighting efficacy. It is noted that numerous modifications and alterations may be made while retaining the teachings of the invention.

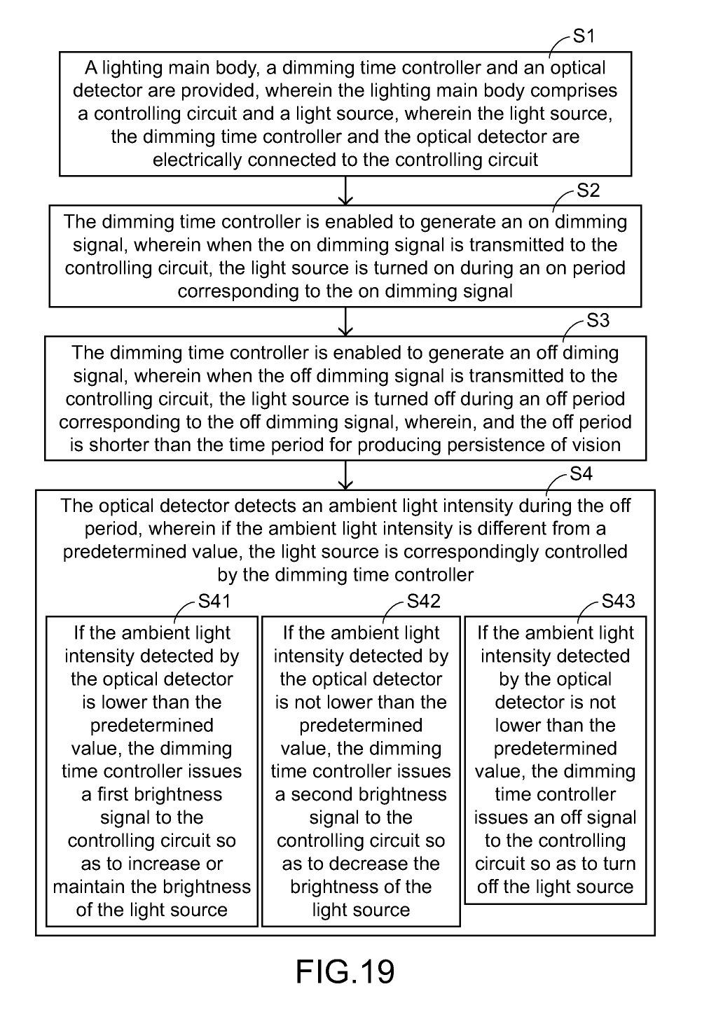

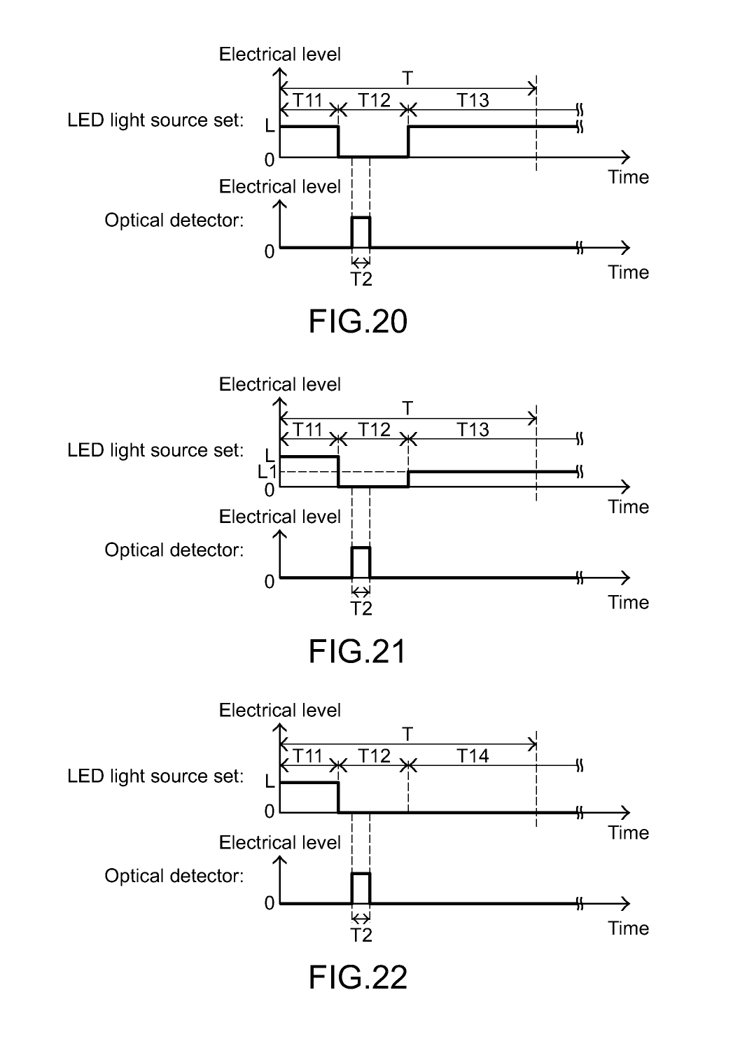

The implementation examples of the optically controlled lighting device will be illustrated with reference to a group control mechanism as described in FIG. 19 and the comparisons between associated signals of the LED light source set 112 and the optical detector of the optically controlled lighting device 1 as described in FIGS. 20˜22. Please refer to FIGS. 1˜7 and 19˜22.

Firstly, in a step S1, a lighting main body, a dimming time controller 15 and an optical detector 16 are provided. The lighting main body comprises a controlling circuit 111 and a light source. As mentioned above, the light source 112 is a LED light source set. The LED light source set 112, the dimming time controller 15 and the optical detector 16 are electrically connected to the controlling circuit 111. In a step S2, the dimming time controller 15 is enabled to generate an on dimming signal. When the on dimming signal is transmitted to the controlling circuit 111, the on dimming signal is correlated with an on period T11. In addition, the LED light source set 112 is turned on during the on period T11. In a step S3, the dimming time controller 15 is enabled to generate an off diming signal. When the off dimming signal is transmitted to the controlling circuit 111, the off dimming signal is correlated with an off period T12. In addition, the LED light source set 112 is turned off during the off period T12. The off period T12 is shorter than the time period for producing persistence of vision. In a step S4, the optical detector 16 detects an ambient light intensity during the off period T12, wherein if the ambient light intensity is different from a predetermined value, the light source set 112 is correspondingly controlled by the dimming time controller 15. In particular, the step S4 is selected from the step S41, the step S42 or the step S43. In the step S41, if the ambient light intensity detected by the optical detector 16 is lower than the predetermined value, the dimming time controller 15 issues a first brightness signal to the controlling circuit 111 so as to increase or maintain the brightness of the LED light source set 112. As shown in FIG. 20, the LED light source set 112 has an initial electrical level L. After the off period T12, the electrical level L of the LED light source set 112 is restored to the initial electrical level L. That is, the LED light source set 112 is re-turned on during the on period T13, and the brightness of the LED light source set 112 is returned to the original brightness. In the step S42, if the ambient light intensity detected by the optical detector 16 is not lower than the predetermined value, the dimming time controller 15 issues a second brightness signal to the controlling circuit 111 so as to decrease the brightness of the LED light source set 112. As shown in FIG. 20, the LED light source set 112 has an initial electrical level L. After the off period T12, the electrical level L of the LED light source set 112 is not restored to the initial electrical level L, but slightly reduced to the electrical level L1. Consequently, the brightness of the LED light source set 112 is decreased. In the step S43, if the ambient light intensity detected by the optical detector 16 is not lower than the predetermined value, the dimming time controller 15 issues an off signal to the controlling circuit 111 so as to turn off the LED light source set 112. As shown in FIG. 22, the LED light source set 112 has an initial electrical level L. After the off period T12, the electrical level L of the LED light source set 112 is not restored to the initial electrical level L, but slightly reduced to a zero electrical level. That is, the LED light source set 112 is turned off during the off period T14. Please refer to FIGS. 20˜22 again. Since the time period for producing persistence of vision is much longer than the time period of turning off the LED light source set 112 (i.e. the off period T12), the off state of LED light source set 112 is too short to be sensed by the eyes of the user. In other words, the user's eyes do not feel uncomfortable. Moreover, the ambient light intensity may be detected by the optical detector 16 just during the off period T12. Of course, the ambient light intensity may be detected by the optical detector 16 during a detecting period T2, which is shorter than the off period T12. In other words, the optically controlled lighting device 1 may be used to detect the ambient light intensity and correspondingly adjust the brightness/darkness of the LED light source set 112. Consequently, the user may be stayed in the situation with good light intensity. By means of this design, it is not necessary to frequently turn on or turn off the light source in response to the change of the ambient light intensity.

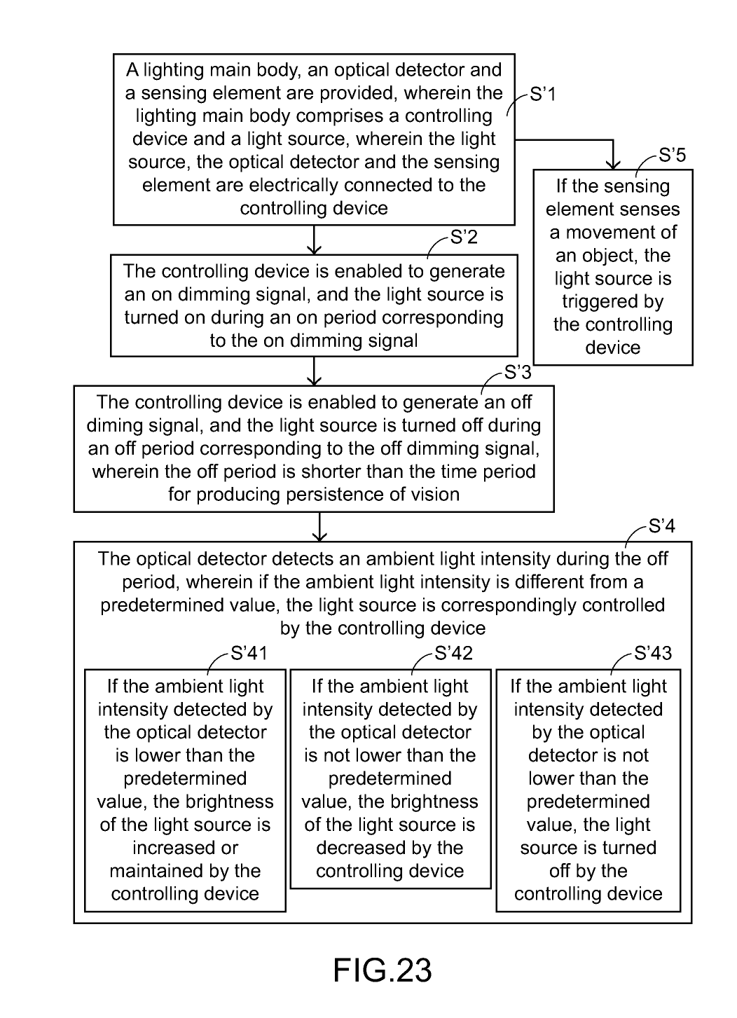

FIG. 23 is a flowchart illustrating a method of performing the group control mechanism according to another embodiment of the present invention. The concepts of this embodiment are similar to those of the above embodiment. In comparison with the above embodiment, the functions of the controlling circuit 111 and the dimming time controller 15 are integrated into the controlling device, and the function of the sensing element is utilized. Firstly, in a step S′1, a lighting main body, an optical detector 16 and a sensing element are provided. The lighting main body comprises a controlling device and a light source. The light source, the optical detector 16 and the sensing element are electrically connected to the controlling device. In a step S′2, the controlling device is enabled to generate an on dimming signal. In addition, the LED light source set 112 is turned on during the on period T11 corresponding to the on dimming signal. In a step S′3, the controlling device is enabled to generate an off diming signal. In addition, the LED light source set 112 is turned off during an off period T12 corresponding to the off dimming signal. The off period T12 is shorter than the time period for producing persistence of vision. In a step S′4, the optical detector 16 detects an ambient light intensity during the off period T12, wherein if the ambient light intensity is different from a predetermined value, the light source set 112 is correspondingly controlled by the controlling device. Moreover, the control method further comprises a step S′5 after the step S′1. In the step S′5, if the sensing element senses a movement of an object, the light source is triggered by the controlling device. By this design, if a human body passes through the sensing region of the sensing element of the optically controlled lighting device of the present invention, the optically controlled lighting device is enabled to illuminate. Moreover, when the above optical detector 16 is applied to the optically controlled lighting device of the present invention, the power-saving purpose can be achieved more easily.

Moreover, the optically controlled lighting device 1 of the present invention further comprises a microwave sensor 12 and an electromagnetic wireless communication module 13. The microwave sensor 12 is used for sensing the movement of the object. The microwave sensor 12 is disposed within the bulb main body 11. In addition, the microwave sensor 12 is electrically connected with the controlling circuit 111. The electromagnetic wireless communication module 13 is disposed within the bulb main body 11. In addition, the electromagnetic wireless communication module 13 is electrically connected with the controlling circuit 111. Through the electromagnetic wireless communication module 13, a group control mechanism between the microwave sensing type LED light bulb 1 and other lighting devices (e.g. sensing type lighting devices or non-sensing type lighting device) may be established or a wireless communication control mechanism of controlling other additional functions may be established.

Moreover, the wireless communication module used in the present invention is an electromagnetic wireless communication module that is operated in a frequency band of an invisible light spectrum. The electromagnetic wireless communication module is at least selected from one of a 313.325 MHz wireless communication module, a 433 MHz wireless communication module, a 418 MHz wireless communication module, a 2.4 GHz wireless communication module, a 5.8 GHz wireless communication module, a 10 GHz wireless communication module, a Bluetooth wireless communication module, a Wi-Fi wireless communication module, a near field communication (NFC) wireless communication module, a Z-Wave wireless communication module and a ZigBee wireless communication module. Alternatively, the wireless communication module used in the present invention is an electromagnetic wireless communication module that is operated in a frequency band of a visible light spectrum. Consequently, the wireless communication module of the present invention may be operated in the frequency band of the visible light spectrum or the invisible light spectrum.

In case that the optically controlled lighting device of the present invention is a light bulb or a light tube, the light source set is a LED light source set comprising one or more LED chips. These LED chips may have identical color temperature or luminance or chroma; or the color temperature or luminance or chroma of at least a portion of the LED chips may be different from the color temperature or luminance or chroma of another portion of the LED chips. Moreover, the sensing element for the light bulb or the light tube is directly combined with the lighting main body of the light bulb or the light tube, which will be described in more details later. That is, the sensing element is not separated or detached from the lighting main body of the light bulb or the light tube.

In case that the optically controlled lighting device of the present invention is one of a sensing type lamp and a sensing type work lamp, the sensing type lamp is at least selected from a sensing type ceiling lamp or a sensing type garden lamp, and the sensing type work lamp is at least selected from a sensing type work lamp with a spraying function or a sensing type work lamp with a humidifying function, but is not limited thereto.

The light source set used in the sensing type lamp or the sensing type work lamp is a LED light source set comprising plural LED chips. Alternatively, the light source set used in the sensing type lamp or the sensing type work lamp is an incandescent light source set or a fluorescent light source set. Of course, the plural LED chips of the LED light source set may have identical color temperature or luminance or chroma; or the color temperature or luminance or chroma of at least a portion of the LED chips may be different from the color temperature or luminance or chroma of another portion of the LED chips.

Moreover, the sensing element for the sensing type lamp or the sensing type work lamp is for example a passive infrared human body sensor (PIR) or a microwave sensor. The sensing element may be directly combined with the lighting main body of the light bulb or the light tube of the sensing type lamp or the sensing type work lamp. Alternatively, the sensing element is detached or separated from the light source (e.g. the light bulb or the light tube) of the sensing type lamp or the sensing type work lamp, but the sensing element is still combined with the lighting main body of the light bulb or the light tube of the sensing type lamp or the sensing type work lamp.

Moreover, the optically controlled lighting device of the present invention further at least comprises a music player and/or a safety monitoring device. The music player and/or a safety monitoring device is disposed within the lighting main body of the sensing type lighting device and electrically connected with the controlling circuit 111.

For example, the music player integrated into the optically controlled lighting device of the present invention is a music player with a built-in function of automatically playing music. Alternatively, the music player may be further integrated with the above-mentioned electromagnetic wireless communication module for receiving an audio signal from a user-operated portable electronic device (e.g. iPhone or iPad) or any other sound playing device and synchronously playing music. Moreover, if the chroma of a portion of the LED chips of the LED light source set and the chroma of another portion of the LED chips are different, the changes of lighting effects are controlled according to the rhythm of the music.

As for the safety monitoring device, a surveillance monitoring device and the above-mentioned electromagnetic wireless communication module may be integrated into the optically controlled lighting device of the present invention. Consequently, according to the result of judging the monitored image, a control command is issued to control the strong illumination of a large area of a specified sensing region.

Moreover, the optically controlled lighting device of the present invention may further comprise at least one charger. The charger is electrically connected to the lighting main body. In case than a utility power source is available, the lighting main body may selectively control any of the utility power source and the at least one charger to provide the electric power to the light source. If the charger is a solar charger, the at least one charger has the highest priority to be connected to the light source. Consequently, the benefits of the optically controlled lighting device are close to the social trend toward power-saving and green products. In case than the utility power source is interrupted, the at least one charger provides electric power to the light source. Consequently, in case of power failure, the at least one charger can be used as an emergency power source.

Moreover, while the optically controlled lighting device utilizes the above-mentioned electromagnetic wireless communication module, the efficacy of adjusting the light intensity of the sub-regions within the lighting space can be adjusted in a more balance and elaborate manner.

Moreover, in case that the optically controlled lighting device is an outdoor optically controlled lighting device, the optically controlled lighting device further at least comprises a solar battery. The solar battery is used as a backup power source. The solar battery may be electrically connected with the above controlling circuit 111.

Hereinafter, various sensing type lighting devices used as the optically controlled lighting device of the present invention will be illustrated by referring to the above descriptions.

Moreover, the bulb main body 11 further at least comprises a male connector 113, a bulb casing 114, and a bulb cover 115. The male connector 113 is located at a first end 1141 of the bulb casing 114. The LED light source set 112 and the bulb cover 115 are both disposed within the bulb casing 114 and located at a second end 1142 of the bulb casing 114, wherein the second end 1142 and the first end 1141 are opposed to each other. Moreover, the LED light source set 112 is covered by the bulb cover 115.

In this embodiment, the bulb casing 114 is a heat-dissipating structure. The heat-dissipating structure 114 has an accommodation part 1140. The accommodation part 1140 is in communication with the first end 1141 and the second end 1142. At least some electronic components of the controlling circuit 111 are accommodated within the accommodation part 1140. Moreover, plural fins 1143 are disposed on an outer surface of the heat-dissipating structure 114. Preferably, the heat-dissipating structure 114 is made of aluminum alloy or other metal alloy. Alternatively, the heat-dissipating structure 114 is made of any other material with heat-dissipating capability, for example a porous ceramic material. Moreover, due to the accommodation part 1140 and/or the fins 1143, the heat generated by the LED light source set 112 can be quickly dissipated away.

Moreover, the bulb cover 115 is at least selected from one of a square cover, a cylindrical cover and a spherical cover, but is not limited thereto.

The implementation example of the microwave sensor 12 is described in FIG. 6. As shown in FIG. 6, a microwave receiving circuit 121 of the microwave sensor 12 comprises a receiving/transmitting antenna 1210. Those skilled in the art will readily observe that a microwave can be successfully transferred through the bulb cover 115. Consequently, the microwave sensor 12 can sense the movement of an object.

Optionally, the microwave sensing type LED light bulb 1 may further comprise an additional electronic device 14. For example, the additional electronic device 14 is a music player and/or a safety monitoring device.

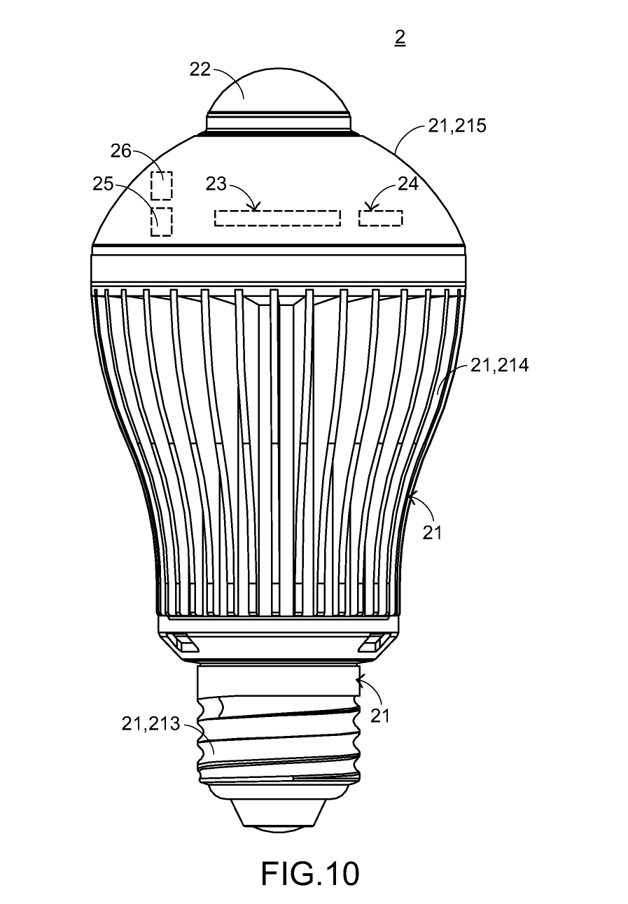

FIG. 10 is a schematic perspective view illustrating a PIR sensing type LED light bulb with a PIR sensor and an electromagnetic wireless communication module and used as an optically controlled lighting device according to an embodiment of the present invention. The PIR sensing type LED light bulb 2 comprises a bulb main body 21, a PIR sensor 22, an electromagnetic wireless communication module 23, a dimming time controller 25 and an optical detector 26. Moreover, the bulb main body 21 further at least comprises a male connector 213, a bulb casing 214, a bulb cover 215, and a controlling circuit (not shown). The controlling circuit within the bulb main body 21 is similar to the controlling circuit 111 of FIG. 1. However, since the controlling circuit within the bulb main body 21 is electrically connected with the PIR sensor 22, the circuitry of the controlling circuit of this embodiment is somewhat different from that of the controlling circuit 111 of FIG. 1. The circuitry of the controlling circuit of this embodiment is well known to those skilled in the art, and is not redundantly described herein.

Moreover, the bulb main body 21 further comprises a LED light source set (not shown). The functions or structures of the LED light source set, the male connector 213, the bulb casing 214, the electromagnetic wireless communication module 23, the dimming time controller 25 and the optical detector 26 are similar to those of the corresponding components of FIG. 1, and are not redundantly described herein.

In comparison with the bulb cover 115 of FIG. 1, the PIR sensor 22 is not shielded by the bulb cover 215 while the sensing action is implemented by the PIR sensor 22. That is, the PIR sensor 22 is protruded outside the bulb cover 215, or the PIR sensor 22 is at least at the same level with the bulb cover 215 and exposed outside.

Optionally, the PIR sensing type LED light bulb 2 may further comprise an additional electronic device 24. For example, the additional electronic device 24 is a music player and/or a safety monitoring device.

The circuit diagram and the control method as described in FIGS. 7˜9 may be applied to the optically controlled lighting device of FIG. 10, and the detailed descriptions thereof are omitted.

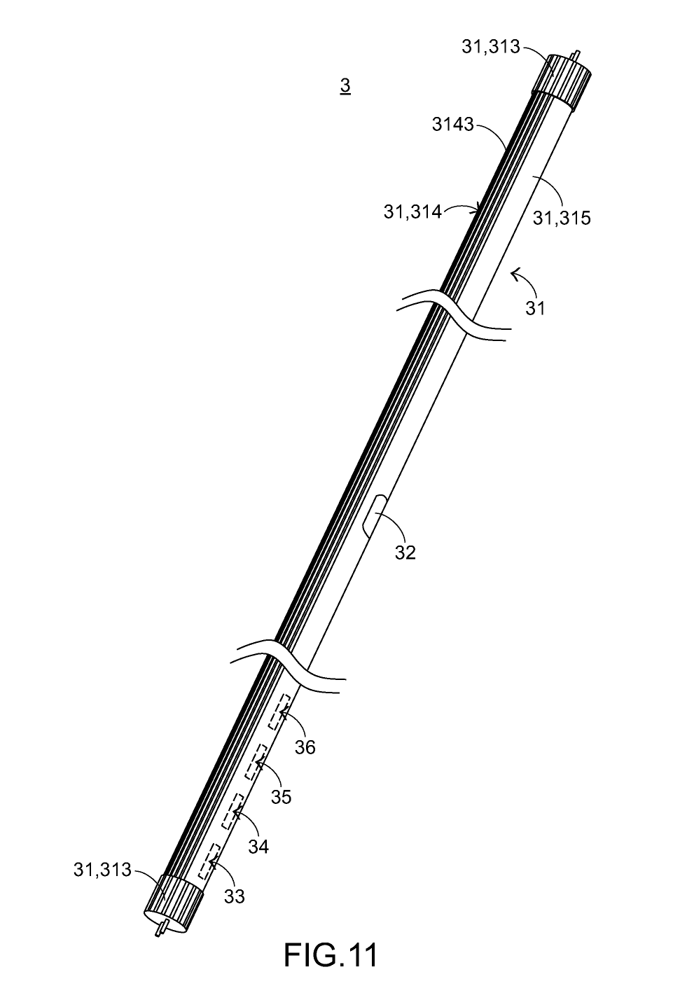

FIG. 11 is a schematic perspective view illustrating a microwave sensing type LED light tube with a microwave sensor and an electromagnetic wireless communication module and used as an optically controlled lighting device according to an embodiment of the present invention. The microwave sensing type LED light tube 3 comprises a tube main body 31, a microwave sensor 32, an electromagnetic wireless communication module 33, a dimming time controller 35 and an optical detector 36. The tube main body 31 is used as a lighting main body. The tube main body 31 at least comprises two tube caps 313, a tube casing 314, a tube cover 315 and a controlling circuit (not shown). The controlling circuit within the tube main body 31 is similar to the controlling circuit 111 of FIG. 1, and is not redundantly described herein.

Moreover, the tube main body 31 further comprises a strip-shaped LED light source set (not shown). The functions or structures of the strip-shaped LED light source set, the two tube caps 313, the electromagnetic wireless communication module 33, the dimming time controller 35 and the optical detector 36 are similar to those of the corresponding components of FIG. 1, and are not redundantly described herein.

Moreover, in this embodiment, the tube casing 314 is a non-closed-circular tube casing (or a non-closed-circular heat-dissipating structure). Moreover, plural fins 3143 are disposed on an outer surface of the non-closed-circular heat-dissipating structure 314. The two tube caps 313 are located at two ends of the non-closed-circular heat-dissipating structure 314, respectively. The strip-shaped LED light source set and the tube cover 315 are both connected to an entrance of the non-closed-circular tube heat-dissipating structure 314. Consequently, the strip-shaped LED light source set, the tube cover 315 and the non-closed-circular tube heat-dissipating structure 314 are combined as a closed circular tube main body. Moreover, the tube cover 315 is a PVC tube cover, but is not limited thereto.

Preferably, the tube casing 314 is a non-closed tube casing. For example, the tube casing 314 is a non-closed-circular tube casing, a non-closed-near-circular tube casing, a non-closed-elliptic tube casing or a non-closed arc-shaped tube casing, but is not limited thereto. Alternatively, the tube casing 314 may be a non-closed tube casing with a shape of one-half circle or a non-closed tube casing with a shape of three-fourth circle, but is not limited thereto.

Optionally, the microwave sensing type LED light tube 3 may further comprise an additional electronic device 34. For example, the additional electronic device 34 is a music player and/or a safety monitoring device.

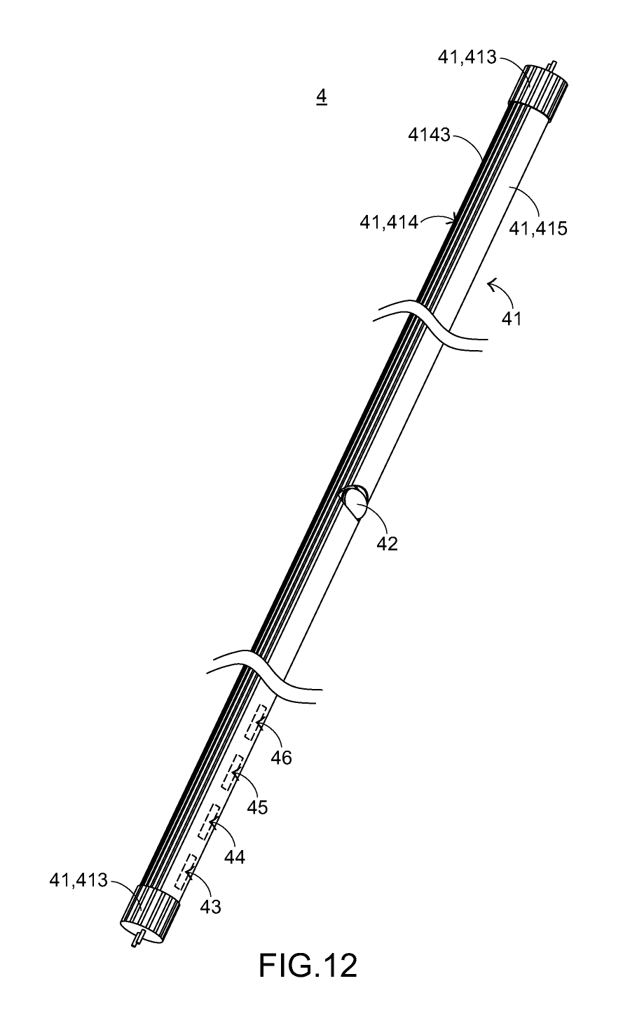

FIG. 12 is a schematic perspective view illustrating a PIR sensing type LED light tube with a PIR sensor and an electromagnetic wireless communication module and used as an optically controlled lighting device according to an embodiment of the present invention. The PIR sensing type LED light tube 4 comprises a tube main body 41, a PIR sensor 42, an electromagnetic wireless communication module 43, a dimming time controller 45 and an optical detector 46. The tube main body 41 is used as a lighting main body. The tube main body 41 at least comprises two tube caps 413, a tube casing 414, a tube cover 415, and a controlling circuit (not shown).

The PIR sensor 42 and the controlling circuit within the tube main body 41 are similar to the PIR sensor 22 and the controlling circuit of FIG. 10, and are not redundantly described herein.

Moreover, the tube main body 41 further comprises a strip-shaped LED light source set (not shown). The functions or structures of the strip-shaped LED light source set, the two tube caps 413, the tube casing 414, the tube cover 415, the electromagnetic wireless communication module 43, the dimming time controller 45, the optical detector 46 and plural fins 4143 on an outer surface of the tube casing 414 are similar to those of the corresponding components of FIG. 11, and are not redundantly described herein.

Optionally, the PIR sensing type LED light tube 4 may further comprise an additional electronic device 44. For example, the additional electronic device 44 is a music player and/or a safety monitoring device.

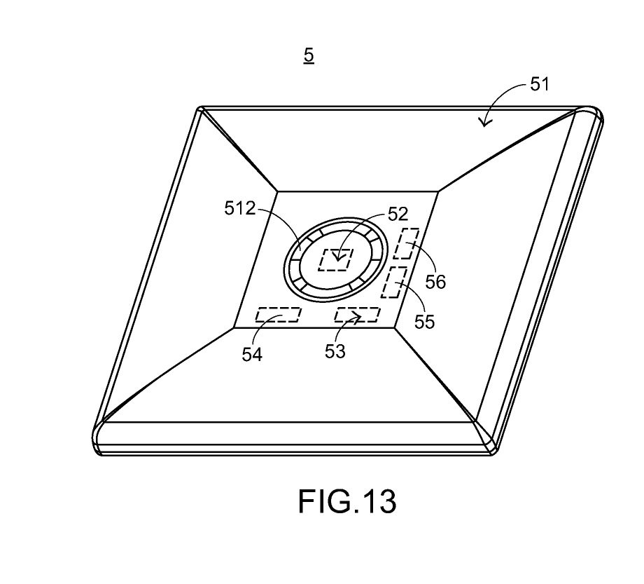

FIG. 13 is a schematic perspective view illustrating a microwave sensing type ceiling lamp with a microwave sensor and an electromagnetic wireless communication module and used as an optically controlled lighting device according to an embodiment of the present invention. The microwave sensing type ceiling lamp 5 comprises a ceiling lamp main body 51, a microwave sensor 52, an electromagnetic wireless communication module 53, a dimming time controller 55 and an optical detector 56. The ceiling lamp main body 51 is used as a lighting main body. The ceiling lamp main body 51 at least comprises a controlling circuit (not shown) and an annular LED light source set 512. The microwave sensor 52 is disposed within the ceiling lamp main body 51.

Optionally, the microwave sensing type ceiling lamp 5 may further comprise an additional electronic device 54. For example, the additional electronic device 54 is a music player and/or a safety monitoring device.

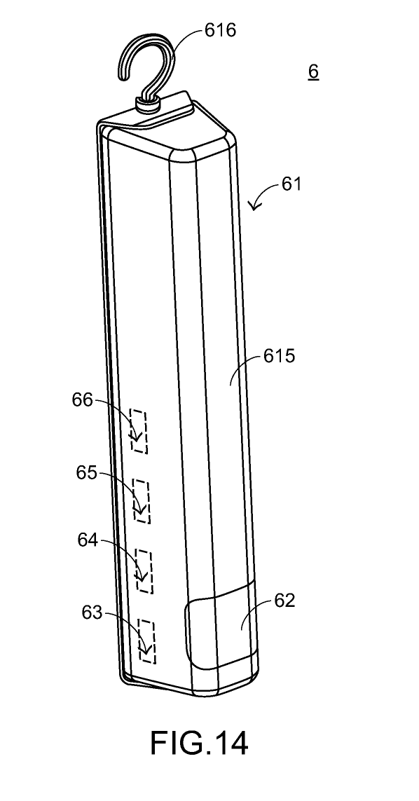

FIG. 14 is a schematic perspective view illustrating a microwave sensing type work lamp with a microwave sensor and an electromagnetic wireless communication module and used as an optically controlled lighting device according to an embodiment of the present invention. The microwave sensing type work lamp 6 (e.g. a microwave sensing type work lamp with a spraying function or a humidifying function) comprises a work lamp main body 61, a microwave sensor 62, an electromagnetic wireless communication module 63, a dimming time controller 65 and an optical detector 66. The work lamp main body 61 is used as a lighting main body. The work lamp main body 61 at least comprises a lamp cover 615, a rotatable hook 616, a controlling circuit (not shown) and a LED light source set (not shown). The microwave sensor 62 is disposed within the work lamp main body 61.

Optionally, the microwave sensing type work lamp 6 may further comprise an additional electronic device 64. For example, the additional electronic device 64 is a music player and/or a safety monitoring device.

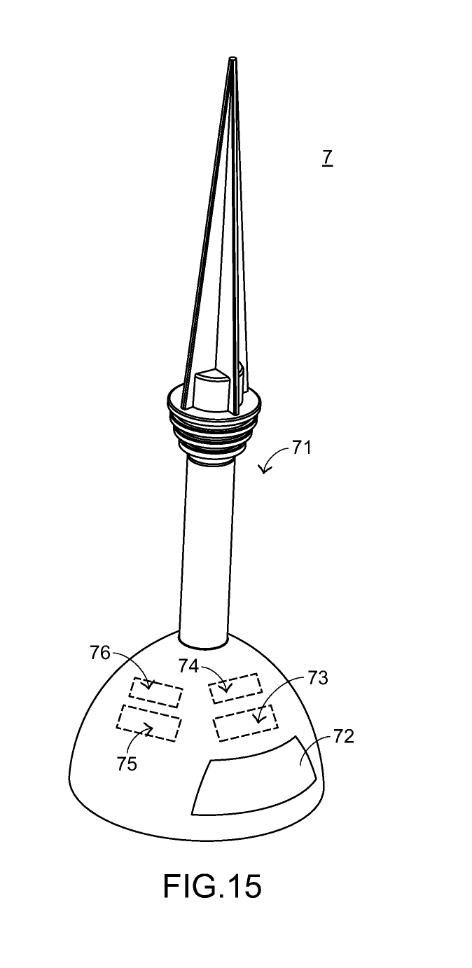

FIG. 15 is a schematic perspective view illustrating a microwave sensing type garden lamp with a microwave sensor and an electromagnetic wireless communication module and used as an optically controlled lighting device according to an embodiment of the present invention. The microwave sensing type garden lamp 7 comprises a garden lamp main body 71, a microwave sensor 72, an electromagnetic wireless communication module 73, a dimming time controller 75 and an optical detector 76. The garden lamp main body 71 is used as a lighting main body. The garden lamp main body 71 at least comprises a controlling circuit (not shown) and a LED light source set (not shown). The microwave sensor 72 is disposed within the garden lamp main body 71.

Optionally, the microwave sensing type garden lamp 7 may further comprise an additional electronic device 74. For example, the additional electronic device 74 is a music player and/or a safety monitoring device

Some implementation examples of a sensing type lighting group including plural above-mentioned optically controlled lighting devices will be illustrated as follows.

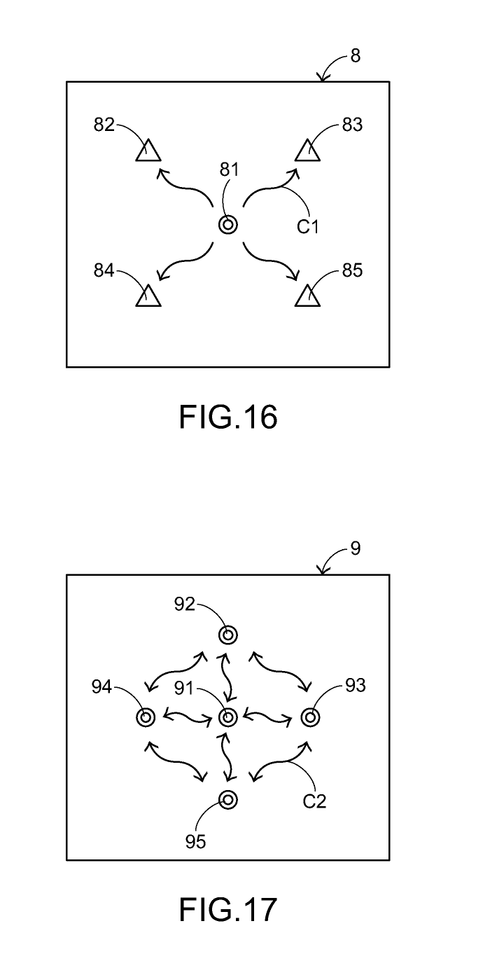

FIG. 16 schematically illustrates a group control mechanism of an optically controlled lighting group including plural optically controlled lighting devices according to a first embodiment of the present invention. As shown in FIG. 16, five optically controlled lighting devices 81˜85 are located within a detection space 8. The optically controlled lighting device 81 is a sensing type lighting device with a dimming time controller, an optical detector, a sensing element and an electromagnetic wireless communication module. In addition, the optically controlled lighting device 81 at least has a master control function.

Each of the optically controlled lighting devices 82˜85 is a non-sensing type lighting device (e.g. an ordinary lighting device) with an electromagnetic wireless communication module. In addition, each of the optically controlled lighting devices 82˜85 only has a controlled function. That is, each of the optically controlled lighting devices 82˜85 can only be passively controlled in response to a wireless lighting control, but each of the optically controlled lighting devices 82˜85 cannot actively issue a control command (e.g. a lighting control command) to other optically controlled lighting devices.

According to an environmental sensing result, the optically controlled lighting device 81 actively controls the light intensity of the light source set of the optically controlled lighting device 81 itself, and simultaneously issues a lighting control command C1 in an electromagnetic wireless communication manner. According to the lighting control command C1, the light intensity of each light source set of the optically controlled lighting devices 82˜85 can be correspondingly controlled.

The above group control mechanism has at least one benefit. For example, in the same space, only one optically controlled lighting device has higher cost, but the other optically controlled lighting devices have lower cost. Under this circumstance, the optimal lighting balance control of the whole space is achieved. Due to the above group control mechanism, the initial installation cost of the optically controlled lighting device is largely reduced.

It is noted that the lighting control command C1 is presented herein for purpose of illustration and description only. That is, the optically controlled lighting device 81 may issue other control commands to execute other additional functions that are mentioned above.

FIG. 17 schematically illustrates a group control mechanism of an optically controlled lighting group including plural optically controlled lighting devices according to a second embodiment of the present invention. As shown in FIG. 17, five optically controlled lighting devices 91˜95 are located within a detection space 9. Each of the optically controlled lighting devices 91˜95 is a sensing type optically controlled lighting device with a dimming time controller, an optical detector, a sensing element and an electromagnetic wireless communication module. In addition, each of the optically controlled lighting devices 91˜95 has both of a master control function and a controlled function.

According to the results of sensing the light intensity changes of sub-regions of respective optically controlled lighting devices 91˜95, the optically controlled lighting devices 91˜95 issues or transmits back a lighting control command C2 to other optically controlled lighting devices in an electromagnetic wireless communication manner. Moreover, a lighting control program may be executed by these optically controlled lighting devices 91˜95 collaboratively. Consequently, a more elaborate lighting balance mechanism can be coordinated.

It is noted that the lighting control command C2 is presented herein for purpose of illustration and description only. That is, these optically controlled lighting devices 91˜95 may issue other control commands to execute other additional functions that are mentioned above.

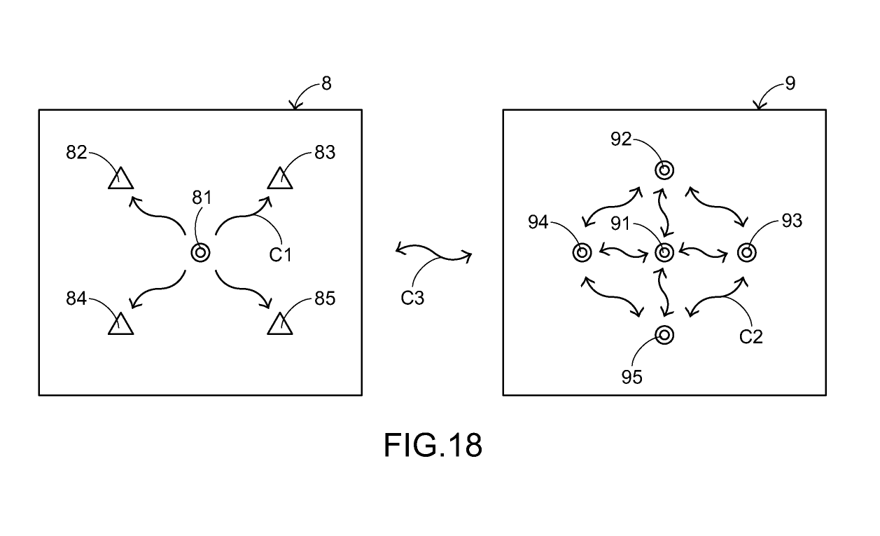

The present invention also relates to another group control mechanism of an optically controlled lighting group in different spaces or different regions. This group control mechanism may be implemented by installing additional electromagnetic wireless communication modules in the optically controlled lighting devices. FIG. 18 schematically illustrates a group control mechanism according to a third embodiment of the present invention by integrating the concepts of the group control mechanism of FIG. 16 with the group control mechanism of FIG. 17. In this embodiment, the optically controlled lighting device 81 may be in communication with and in coordination with the optically controlled lighting devices 91˜95 through a lighting control command C3 and another lighting control program.

From the above descriptions, the optically controlled lighting device of the present invention is equipped with a dimming time controller to control the on state and the off state of the lighting main body. Moreover, during an off period that the lighting main body is in the off state, an ambient light intensity is detected by the optical detector in order to judge whether the brightness of the ambient light is sufficient. If the brightness of the ambient light is sufficient, the brightness of the lighting main body is decreased or the light source of the lighting main body is turned off. If the brightness of the ambient light is insufficient, the brightness of the lighting main body is increased or maintained. By means of this design, the optical detector is not away from the lighting main body. Moreover, since the off period is shorter than the time period for producing persistence of vision, the flickering light of the optically controlled lighting device is not sensed by the human eyes. Moreover, since the optically controlled lighting device selectively implements the lighting action according to the result of judging the ambient light intensity, the purposes of saving electric power and balancing the brightness of the lighting zone can be achieved. Moreover, since the user does not need to frequently turn on and turn off the light source, the switch of the light source can be continuously in the on state.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An optically controlled lighting device, comprising:
a lighting main body comprising a controlling circuit and a light source, wherein the light source is electrically connected with the controlling circuit;
a dimming time controller coupled to the controlling circuit, and generating an on dimming signal and an off diming signal, wherein when the on dimming signal is transmitted to the controlling circuit, the light source is turned on during an on period corresponding to the on dimming signal, wherein when the off dimming signal is transmitted to the controlling circuit, the light source is turned off during an off period corresponding to the off dimming signal; and
an optical detector coupled to the controlling circuit, and detecting an ambient light intensity,
wherein the off period is shorter than a time period for producing persistence of vision, wherein if the ambient light intensity detected by the optical detector is different from a predetermined value, the light source is controlled by the dimming time controller.

2. The optically controlled lighting device according to claim 1, further comprising a sensing element that senses a movement of an object, wherein the sensing element is disposed within the lighting main body and electrically connected with the controlling circuit.

3. The optically controlled lighting device according to claim 2, wherein the optically controlled lighting device is at least selected from one of a sensing type LED light bulb, a sensing type LED light tube, a sensing type lamp and a sensing type work lamp, wherein the sensing type lamp is at least selected from a sensing type ceiling lamp or a sensing type garden lamp, and the sensing type work lamp is at least selected from a sensing type work lamp with a spraying function or a sensing type work lamp with a humidifying function.

4. The optically controlled lighting device according to claim 3,
wherein if the optically controlled lighting device is the sensing type LED light bulb, the sensing type LED light bulb comprises a bulb main body, and the bulb main body is used as the lighting main body, wherein the bulb main body further at least comprises a male connector, a bulb casing, a LED light source set and a bulb cover, wherein the male connector is located at a first end of the bulb casing, the LED light source set and the bulb cover are both disposed within the bulb casing and located at a second end of the bulb casing opposed to the first end of the bulb casing, and the LED light source set is covered by the bulb cover, wherein the bulb casing is a heat-dissipating structure with an accommodation part, the accommodation part is in communication with the first end and the second end, at least one electronic component of the controlling circuit is accommodated within the accommodation part, plural fins are disposed on an outer surface of the heat-dissipating structure, the male connector is located at the first end of the heat-dissipating structure, and the LED light source set and the bulb cover are both located at the second end of the heat-dissipating structure; or
wherein if the optically controlled lighting device is the sensing type LED light tube, the sensing type LED light tube comprises a tube main body, and the tube main body is used as the lighting main body, wherein the sensing type LED light tube further at least comprises two tube caps, a non-closed-circular tube casing, a LED light source set and a tube cover, wherein the two tube caps are respectively located at two ends of the non-closed-circular tube casing, the LED light source set and the tube cover are both connected to an entrance of the non-closed-circular tube casing, and the LED light source set is covered by the tube cover, wherein the non-closed-circular tube casing is a non-closed-circular heat-dissipating structure, plural fins are disposed on an outer surface of the non-closed-circular heat-dissipating structure, the two tube caps are respectively located at the two ends of the circular heat-dissipating structure, and the LED light source set and the tube cover are both connected to the entrance of the non-closed-circular heat-dissipating structure; or
wherein if the sensing type lamp is the sensing type ceiling lamp or the sensing type garden lamp or the sensing type work lamp is the sensing type work lamp with the spraying function or the sensing type work lamp with the humidifying function, the light source is a LED light source set comprising plural LED chips, or the light source is an incandescent light source set or a fluorescent light source set.

5. The optically controlled lighting device according to claim 1,
wherein the optically controlled lighting device further comprises an electromagnetic wireless communication module, wherein the electromagnetic wireless communication module is disposed within the lighting main body and electrically connected with the controlling circuit, wherein the electromagnetic wireless communication module is operated in a frequency band of an invisible light spectrum, and the electromagnetic wireless communication module is at least selected from one of a 313.325 MHz wireless communication module, a 433 MHz wireless communication module, a 418 MHz wireless communication module, a 2.4 GHz wireless communication module, a 5.8 GHz wireless communication module, a 10 GHz wireless communication module, a Bluetooth wireless communication module, a Wi-Fi wireless communication module, a NFC wireless communication module, a Z-Wave wireless communication module and a ZigBee wireless communication module; or
wherein the optically controlled lighting device further comprises an electromagnetic wireless communication module, wherein the electromagnetic wireless communication module is disposed within the lighting main body and electrically connected with the controlling circuit, wherein the electromagnetic wireless communication module is operated in a frequency band of a visible light spectrum.

6. The optically controlled lighting device according to claim 1, wherein the optically controlled lighting device further at least comprises a music player and/or a safety monitoring device, wherein the music player and/or the safety monitoring device are disposed within lighting main body and electrically connected with the controlling circuit.

7. The optically controlled lighting device according to claim 1, wherein the optically controlled lighting device is an outdoor optically controlled lighting device, and the outdoor optically controlled lighting device further comprises a solar battery, wherein the solar battery is electrically connected with the controlling circuit.

8. The optically controlled lighting device according to claim 1, further comprising at least one charger, wherein the charger is electrically connected to the lighting main body, wherein if a utility power source is available, the lighting main body selectively controls any of the utility power source and the at least one charger to provide electric power to the light source, wherein if the utility power source is interrupted, the at least one charger provides electric power to the light source.

9. An optically controlled lighting group, comprising:
a first optically controlled lighting device comprising a first light source, a first communication module, a dimming time controller, an optical detector and a first controlling circuit, wherein the first controlling circuit is electrically connected with the first light source, the first communication module, the dimming time controller and the optical detector; and
a second optically controlled lighting device comprising a second light source, a second communication module and a second controlling circuit, wherein the second controlling circuit is electrically connected with the second light source and the second communication module,
wherein the dimming time controller is coupled with the first second controlling circuit, and generates an on dimming signal and an off diming signal, wherein when the on dimming signal is transmitted to the first controlling circuit, the first light source is turned on during an on period corresponding to the on dimming signal, wherein when the off dimming signal is transmitted to the first controlling circuit, the first light source is turned off during an off period corresponding to the off dimming signal,
wherein the off period is shorter than a time period for producing persistence of vision, wherein if the ambient light intensity detected by the optical detector is different from a predetermined value, the first light source is controlled by the dimming time controller.

10. The optically controlled lighting group according to claim 9, wherein the first optically controlled lighting device further comprises a first sensing element that senses a movement of an object, and the first sensing element is electrically connected with the first controlling circuit, wherein according to an environmental sensing result of the first sensing element, a communication channel between the first communication module and the second communication module is established, so that a light intensity of the first light source and/or the second light source is correspondingly controlled.

11. The optically controlled lighting group according to claim 10, wherein the first optically controlled lighting device has a master control function, and the second optically controlled lighting device has a controlled function, wherein according to the environmental sensing result, the light intensity of the first light source is actively controlled by the first optically controlled lighting device, and the light intensity of the second light source of the second optically controlled lighting device is controlled in response to a control command from the first optically controlled lighting device.

12. The optically controlled lighting group according to claim 10 or 11, wherein the second optically controlled lighting device further comprises a second sensing element, wherein the communication channel between the first communication module and the second communication module is established according to the environmental sensing result, so that the light intensity of the first light source and/or the second light source is correspondingly controlled.

13. The optically controlled lighting group according to claim 12, wherein each of the first optically controlled lighting device and the second optically controlled lighting device has both of the master control function and the controlled function, wherein when a lighting control program is automatically executed by the first optically controlled lighting device and the second optically controlled lighting device, the light intensity of the first light source and/or the second light source is correspondingly controlled.

14. An optically controlled lighting device, comprising:
a controlling part, wherein the optically controlled lighting device is turned on or turned off under control of the controlling part;
an optical control part detecting a brightness of an ambient light,
wherein the controlling part and the optical control part are disposed within the optically controlled lighting device, and the controlling part and the optical control part are electrically connected with each other, wherein after the optically controlled lighting device is turned on, the optically controlled lighting device is turned off by the controlling part at fixed time intervals, wherein while the optically controlled lighting device is turned off, the optical control part detects the brightness of the ambient light.

15. The optically controlled lighting device according to claim 14, wherein the optically controlled lighting device is turned on or turned off under control of the controlling part according to a detecting result of detecting the brightness of the ambient light by the optical control part, wherein the optical control part is a photosensitive sensing circuit.

16. The optically controlled lighting device according to claim 14, wherein the optically controlled lighting device further comprises a sensing part that senses whether a human body appears, wherein the sensing part is connected to the controlling part, wherein the optically controlled lighting device is turned on or turned off under control of the controlling part according to a detecting result of detecting the brightness of the ambient light by the optical control part and a sensing result of sensing whether the human body appears in an illuminated region by the sensing part.

17. The optically controlled lighting device according to claim 14, further comprising a LED light source set, wherein the LED light source set comprises plural LED chips, wherein the plural LED chips have identical color temperature or luminance or chroma, or the color temperature or the luminance or the chroma of at least a portion of the plural LED chips is different from that of another portion of the plural LED chips.

18. The optically controlled lighting device according to claim 14, wherein the optically controlled lighting device is at least selected from one of a sensing type LED light bulb, a sensing type LED light tube, a sensing type lamp and a sensing type work lamp, wherein the sensing type lamp is at least selected from a sensing type ceiling lamp or a sensing type garden lamp, and the sensing type work lamp is at least selected from a sensing type work lamp with a spraying function or a sensing type work lamp with a humidifying function.

19. A control method for an optically controlled lighting device, the control method at least comprising steps of:
(a) providing a lighting main body, a dimming time controller and an optical detector, wherein the lighting main body comprises a controlling circuit and a light source, wherein the light source, the dimming time controller and the optical detector are electrically connected to the controlling circuit;
(b) enabling the dimming time controller to generate an on dimming signal, wherein when the on dimming signal is transmitted to the controlling circuit, the light source is turned on during an on period corresponding to the on dimming signal;
(c) enabling the dimming time controller to generate an off diming signal, wherein when the off dimming signal is transmitted to the controlling circuit, the light source is turned off during an off period corresponding to the off dimming signal, wherein the off period is shorter than the time period for producing persistence of vision; and
(d) allowing the optical detector to detect an ambient light intensity during the off period, wherein if the ambient light intensity detected by the optical detector is different from a predetermined value, the light source is correspondingly controlled by the dimming time controller.

20. The control method according to claim 19, wherein the step (d) further comprises:
(d1) if the ambient light intensity detected by the optical detector is lower than the predetermined value, the dimming time controller issuing a first brightness signal to the controlling circuit so as to increase or maintain a brightness of the light source; or
(d2) if the ambient light intensity detected by the optical detector is not lower than the predetermined value, the dimming time controller issuing a second brightness signal to the controlling circuit so as to decrease the brightness of the light source; or
(d3) if the ambient light intensity detected by the optical detector is not lower than the predetermined value, the dimming time controller issuing an off signal to the controlling circuit so as to turn off the light source.

21. The control method according to claim 20, wherein the controlling circuit is further electrically connected with a sensing element, wherein a movement of an object is sensed by the sensing element, and the sensing element is disposed within the lighting main body.

22. A control method for an optically controlled lighting device, the control method at least comprising steps of:
(a′) allowing the optically controlled lighting device to be in an off state at fixed time intervals after the optically controlled lighting device is in an on state;
(b′) detecting a brightness of an ambient light while the optically controlled lighting device is in the off state;
(c′) if the brightness of the ambient light is higher than a predetermined value, allowing the optically controlled lighting device to be maintained in the off state, and repeatedly performing the step (b′), and if the brightness of the ambient light is lower than or equal to the predetermined value, allowing the optically controlled lighting device to be in the on state, and repeatedly performing the step (a′).

23. The control method according to claim 22, wherein if the brightness of the ambient light is higher than the predetermined value in the step (c′), the optically controlled lighting device is maintained in the off state, and the step (b′) is repeatedly done, wherein if the brightness of the ambient light is lower than or equal to the predetermined value in the step (c′), the control method further comprises a step of judging whether a human body appears, wherein if no human body appears, the optically controlled lighting device is maintained in the off state, and the step (b′) is repeatedly done, wherein if the human body appears, the optically controlled lighting device is turned on, and the step (a′) is repeatedly done.
